(19) United States
(12) Patent Application Publication
(10) Pub. No.: US 2005/0148372 A1
(43) Pub. Date: Jul. 7, 2005

(54) Wireless visual messaging system using two-way transreceivers

(76) Inventor: Ben Lowinger, New York, NY (US)

Correspondence Address: Charles H. Helein;The Helein Law Group, LLLP, Suite 700, 8180 Greensboro Drive, McLean, VA, 22102, US

(21) Appl. No.: 11/019,210

(22) Filed: Dec. 23, 2004

Related U.S. Application Data
(60) Provisional application No. 60/531,974, filed on Dec. 24, 2003.

(51) Int. Cl. H04M 1/00

(52) U.S. Cl. 455/567; 455/566

(57) ABSTRACT

The wireless text messaging system using radio transceivers operating on a radio band of the electromagnetic frequency spectrum allocated by the FCC designated as the GMRS and the FRS radio frequencies, with each transceiver programmed with a database of signs, symbols, and alphabet activated by an electronic impulse by depressing a text button on the unit. Each transceiver has status detection means and detects an incoming message and operational status including the connection status of the signaled transceiver notifying the sending transceiver of the operating status of the signaled transceiver. Each transceiver has status administration means and decision means. The status administration means retain the operational status of the transceiver notified from the status detection means for each user. The decision means determines a send mode according to the operational status of the signaled transceiver.

### CROSS REFERENCE TO RELATED APPLICATIONS

This application claims priority from the provisional application No. 60/531,974 filed on Dec. 23, 2003.

### FIELD OF THE INVENTION

The invention relates to a wireless visual messaging system using two-way transreceivers, operating on discrete segment of electromagnetic frequency spectrum. More particularly on a discrete segment of electromagnetic frequency spectrum designated as Family Radio Service (FRS)and General Mobile Radio Service (GMRS) radio frequencies for sending and receiving visual messages, the apparatus consisting of hand held radio system, that also provides two-way voice communication by transmission and reception over an area identified by the strength of the signal, and subject to local laws.

### BACKGROUND OF THE INVENTION

Existing wireless visual messaging systems normally rely on networking that combines radio and wire to link switching centers over discrete geographical areas. The coverage area and availability of the messaging services are subject to the accessibility and location of the switching center. Further the switching centers provide their services at a subscription price.

In addition the state of art of telecommunications primarily by two way hand held radio system are found in U.S. Pat. Nos. 6,584,306; 5,689,802; 5,812,951; 5,548,810; 5,265,264; 5,173,795; 5,109,525; 4,718,110 and 3,939,418, however all these patents disclose two way radios that transmit and receive audio signals.

The communication of voice and textual data between two way wireless devices can be found in U.S. Pat. No. 6,763,226 B1 which discloses a multifunctional world wide walkie talkie, and is based on wireless computer technology, satellite communications and digital cellular communications related to local/wide area networks and Internet protocol telephony communications. The text chat feature of the walkie talkie device depends on the internet and the VOIP technology, the WIPO Patent No.: WO03007583A1 discloses a toy radio phone operates on FRS bands, communicates information, such as voice, and digital data, over a distance ranging from five hundred feet up to two miles or more. The patent No. WO03007583A1 communicates voice and textual data between two wireless devices operating on FRS frequency band but fails to disclose the transreceiver. Further, these patents do not disclose any technology to communicate other type of visual messages.

For the purpose of this discussion hereinafter the word “message” will include any visual or audio visual message that includes a text message or a pictorial message or a graphical message or a video message or any combination thereof. Further the word “messaging system” will include any system that enables exchanging of a “Message” by a hand held wireless communication device that does not require any addition network or switching center to support its operation.

It is therefore, observed that there is a need of Wireless Visual Messaging System Using Two-way Transreceivers, which does not have above and other limitations.

It is observed that there is a need of a Wireless visual Messaging System Using Two-way Transreceivers which is hand held.

It is observed that there is a need of a Wireless Messaging System Using Two-way Radio Transreceivers that does not depend upon availability of switching centers.

It is observed that there is a need of a wireless messaging system capable of operating independent of a communications network.

It is observed that there is a need of walkie-talkie, which is a Wireless Messaging System Using Two-way Transreceivers capable of exchanging text or graphical or voice messages or any combination thereof.

### SUMMARY AND OBJECTS OF THE INVENTION

It is therefore an object of the invention to obviate above and other drawbacks from the existing art.

The object of the present invention is to provide a new device and method, having many novel features not provided in prior art, that results in a new method of sending and receiving visual messages through two-way transreceivers. The invention may be used in any locale subject to its technical design imperatives. The ubiquity of the visual messaging capability unrestrained by unit pricing (per message), while also combining voice communications makes the invention a device composed of features and functionalities that are not apparent or obvious by any of the prior art apparatus.

Accordingly an object of the present invention is to provide a messaging system to a hand held two-way transreceivers device, that will overcome the limitation of only voice message communication of prior art.

Another object of the present invention is to provide a wireless device, using radio frequencies allocated for the FRS and GMRS radio services by the FCC, to deliver messages in textual or any other visual format.

Another object of the present invention is to provide a wireless device, using radio frequencies allocated for the FRS and GMRS radio services by the Federal Communications Commission (FCC) that operates independent of a communications network.

Another object of the present invention is to provide a wireless device using radio frequencies allocated for the FRS and GMRS radio services by the FCC, that operates at ranges up to 10 miles in any locale in which radio signals may be sent and received.

Another object of the present invention is to provide a wireless device using radio frequencies allocated for the FRS and GMRS radio services by the FCC, that is hand held.

Another object of the present invention is to provide a wireless device using radio frequencies allocated for the FRS and GMRS radio services by the FCC, to permit user choice in transmitting messages by either voice or text or visual or any combination thereof by depressing the controls on the device.

Another object of the present invention is to provide a wireless device using radio frequencies allocated for the FRS and GMRS radio services by the FCC, that provides visual messaging capabilities without usage charges for any transmitted or received visual message.

Another object of the present invention is to provide a wireless device using radio frequencies allocated for the FRS and GMRS radio services by the FCC, that provides status detection for incoming and outgoing text, visual messages or both allowing the user to administer and manage his sending and receiving text, visual or both messages independent of any network, i.e., from the hand held unit itself.

Another object of the present invention is to provide a wireless device using radio frequencies allocated for the FRS and GMRS radio services by the FCC, that permits multiple signal paths to be used to transmit and receive messages.

Another object of the present invention is to provide a wireless device using radio frequencies allocated for the FRS and GMRS radio services by the FCC, that by using multiple signal paths to be used to transmit and receive messages in the format text, visual, audio or any combination thereof, minimizes delays in sending or receiving said messages that would be caused by congestion of single channel systems.

Another object of the present invention is to provide a wireless device using radio frequencies allocated for the FRS and GMRS radio services by the FCC, that permits multiple signal paths to be used to transmit and receive messages that enhances security of the messages.

Another object of the present invention is to provide a wireless device using radio frequencies allocated for the FRS and GMRS radio services by the FCC, that is universally functional in today's market than the prior art devices.

To obviate above and other limitations from the existing art and to achieve above objects, the instant invention provides a wireless communications apparatus using two-way radio devices, and method to send and receive visual messages, which is simple in construction, more universally usable and more versatile in operation, than known devices of this kind.

The invention here does not need a network of interrelated facilities to operate, therefore not constrained by the particular footprint of the network's coverage area.

According to one aspect of the instant invention provides a portable two-way wireless system, comprising a transreceiver for transmitting and receiving electromagnetic radiations, a selective call decoder coupled to the transceiver for decoding radiations, a user interface connected to said transreceiver through a processor for compiling and displaying visual messages, the processor coupled to the, selective call decoder and said transceiver for identifying the visual message from decoded radiations or for encoding compiled message in to corresponding radiations for providing a wireless visual messaging system using a transreceiver for exchanging visual messages.

Further according to another aspect of the processor of the invention includes a first processor for receiving and displaying a visual message from the selective call decoder. The received visual message is decoded by the selective call decoder and passed directly to the first processor to display the text message in one or two lines, each line having a maximum of 10 characters in dot matrix format.

According to yet another aspect of the invention the portable messaging system is used for exchanging visual messages which includes text or picture or video or audio visual messages.

According to yet a further aspect of the invention the portable messaging system encrypt or decrypt the received visual message by the first processor and coupled to a secure memory that retains information encrypted from the message.

According to an additional aspect of the invention the portable messaging system comprises a received message session key.

According to another additional aspect of the invention the processors of the portable messaging system includes a secure message generator.

According to yet an additional aspect of the invention the processors of portable messaging system encrypt and the message generator generates a visual/text message that is coupled to the processor for transmission by the transceiver.

According to yet a further additional aspect of the invention the portable messaging system comprises a readable message.

According to one another aspect of the invention the portable messaging system is a walkie-talkie.

According to a second aspect of the invention a portable messaging system is provided which comprises, a receiver, a selective call decoder coupled to the receiver, a processor coupled to the selective call decoder, a transceiver coupled to the processor, and a user interface connected to said processor for compiling and displaying visual messages, for providing a portable messaging unit system for exchanging visual messages.

According to a third aspect of the invention a portable messaging system is provided wherein the text processor comprises, a security code processor, a secure non volatile read only memory coupled to the security code processor, a secure erasable read only memory coupled to the secure non volatile read only memory, an input/output interface coupled to the secure erasable read only memory, and control logic coupled to the security code processor, the secure non volatile read only memory, the secure erasable read only memory, and the input/output interface, a processor having visual or text processor connected the selective call decoder, and a transreceiver coupled to the processor.

According to a fourth aspect of the invention a portable two-way text messaging system is provided wherein the visual or text processor receives and encrypts a visual/text message coupled from the selective call decoder.

According to the fifth aspect of the invention a portable messaging system is provided wherein a sub-audible tone or sub-code is transmitted with the received visual/text message.

According to the sixth aspect of the invention a portable two-way text messaging system wherein the sub-audible tone or sub-code is decoded by the selective call decoder and matched to a corresponding sub-code to prevent reception of unauthorized transmissions of visual/text messages.

The invention further provides a method according to a sixth aspect of the invention a method to send and receive visual/text messaging comprising the steps of: providing a hand held two way communication device; receiving/transmitting electromagnetic radiations to/from said hand held communication device; encoding/decoding said received/transmitted radiations using selective call decoder; identifying visual message from decoded radiations through a processor, and; displaying visual message using an user interface;

According to a seventh aspect of the invention the method of the invention further provides step of encoding or decoding includes steps of encrypting/decrypting the massage in a secured format.

According to a eighth aspect of the invention the method of the invention further provides step of receiving/transmitting includes step of storing said received or transmitted message in a memory.

### BRIEF DESCRIPTION OF FIGURES

The invention will now be described with reference to the accompanying figures.

FIG. 1 is a schematic or block diagram of a wireless messaging device using two-way radio transreceivers in accordance with the present invention.

FIG. 2 is block diagram of an embodiment of wireless messaging device using two-way radio transreceivers in accordance with the present invention.

FIG. 3 is a block diagram of another embodiment of wireless messaging device using two-way radio transreceivers in accordance with the present invention.

FIG. 4 is a first view of a wireless messaging device using two-way radio transreceivers.

FIG. 5 is a second view of a wireless messaging device using two-way radio transreceivers.

FIG. 6 is a third view of a wireless messaging device using two-way radio transreceivers.

### DETAILED DESCRIPTION OF THE INVENTION

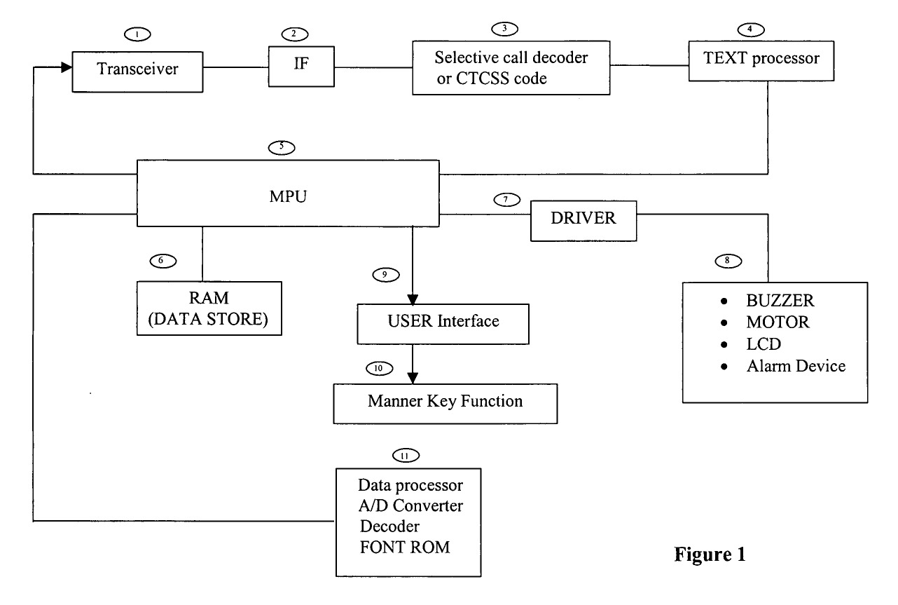

FIG. 1 is a block diagram of a wireless the messaging system using two-way radio transceivers, illustrates a transceiver (1) which is a mobile two-way text messaging system embodied in the two-way radio device authorized under the FRS and GMRS rules of the FCC, IF (2) the radio frequencies assigned by the FCC for use as FRS and GMRS radios, Selective call decoder or Continuous Tone Coded Squelch System (CTCSS), (3) for decoding the received visual/text messages by selective call decoder. The same channel and CTCSS code are to be maintained when visual/text message data is sent and received. The selective call decoder provides its output to a visual or text processor (4) for decoding the visual or text message, which after processing the data provides its output to a Micro Processor Unit (MPU), (5) for processing sent/received data. The visual or text processor (4) can be embodied within the Micro processor using (5). The fully decoded visual data/text can be stored in a Random Access Memory (RAM) (6), the total capacity of the memory depends on the volume of characters in a message. A driver (7) connected to the MPU coupled with message receiving indicator (8) to indicate receipt of a message, by using a buzzer, motor, and LCD, LED, and alarm device. A user interface (9) which provides functions such as individual message delete function, duplicate message indication, unread message indication, message full message indication, service area indication, set alert, tone melody/vibrator/silent, all message delete function, receiving beeping. Manner key functions (10) have a PTT button to terminate text or visual message compiling mode, a Power button to select visual/text characters while in the text message mode, a Send button to send text message after text entering is terminated on text mode, a Move button to move right, left, next, before while in text mode, an UP Arrow/Scroll Up button to scroll up by pressing the button to the next character while in the text mode, a DOWN Arrow/Scroll button to scroll down by pressing the button to the next character while in the text mode, a character selecting button to select Data processor (11) A/D, Converter, decoder, and FONT RAM for processing.

To send a message, the user compiles the message. Thereafter the user is prompted to send or not to send the message. If the message is to be sent, the user presses the “SEND” button. Approximately thirty characters can be sent in one second transmission per thirty seconds of time allotted by FCC rules. However, a person skilled in the art will appreciate that the number of characters or bits per second is not a limiting factor to the invention. To receive a message, an audible beeping signal With the “Message” icon blinks to indicate to view the message, the user has to press the “SHOW:UP” button, and the text of the message is displayed. Multiple messages received are displayed sequentially. To store the message, “STORE:UP” button is selected, all the selected text is shown. If the number of characters are more than the display's capacity, the user is asked whether to store the message or not. To delete a message, the “NO:DOWN” button is selected and the message is deleted.

To enter or edit messages the user selects the “TEXT” or any other appropriate mode for editing mode of the display of the function options. In case of TEXT mode a “TEXT” icon appears and prompt the user to indicate whether to review the received and sent messages. If the user selects the “YES:UP” button, the display indicates the number of the stored message and a cursor blinks on the number.

To edit the displayed selected message, the “EDIT:UP” button is selected the user is asked whether to edit or not. If the user wishes to edit, the cursor blinks on the first position. The user then searches for the desired character to be edited by using the “SCROLL: (UP, DOWN) buttons. The cursor automatically moves to the next character position. The procedure is repeated to select the desired characters. To edit a selected character, the user presses the “MOVE LEFT/RIGHT” buttons.

To search the desired message by number, the user uses the “SCROLL (UP, DOWN)” buttons, selects the desired number and press “ENTER.” The selected message is displayed sequentially asking the viewer to view other messages or not. If the user wishes to review other messages, the same steps are repeated to select another number after the “OTHER:UP” button is pressed. To terminate a session, the “END” button is pressed for more than two seconds.

The invention herein is largely described with reference to the text messages however, a person skilled in the art will appreciate that the similar description for editing, receiving, transmitting of other type of visual messages including pictures/videos or any other audio visual messages is possible. The message can be either text, picture, video, audio, or an audio-visual message, all of which are defined herein as a message unit. The invention described herein is not limited to above description, any other embodiment implementing the concept of instant invention will fall under the scope of the present invention and will be the subject matter of the protection. An alert can be activated or sent simultaneously with any message unit, to alert the user that a message has been received.

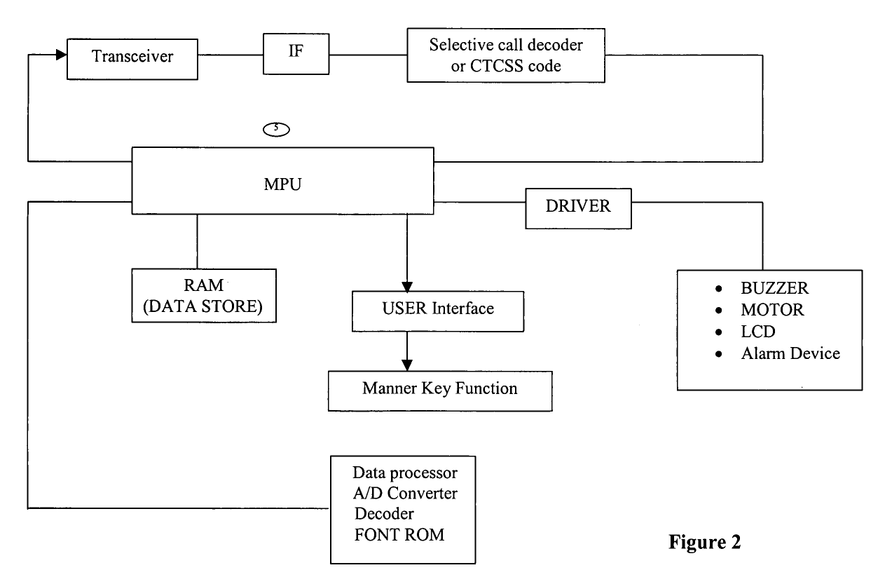

FIG. 2 shows another embodiment of the invention having the visual processor within the MPU (5).

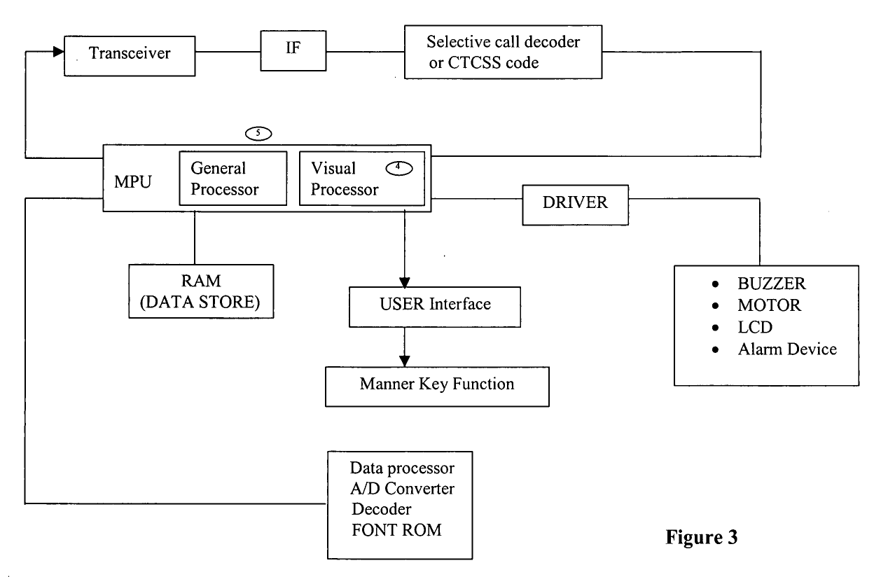

FIG. 3 shows yet another embodiment of the MPU (5) showing a general purpose processor and a visual processor embodied within the MPU (5).

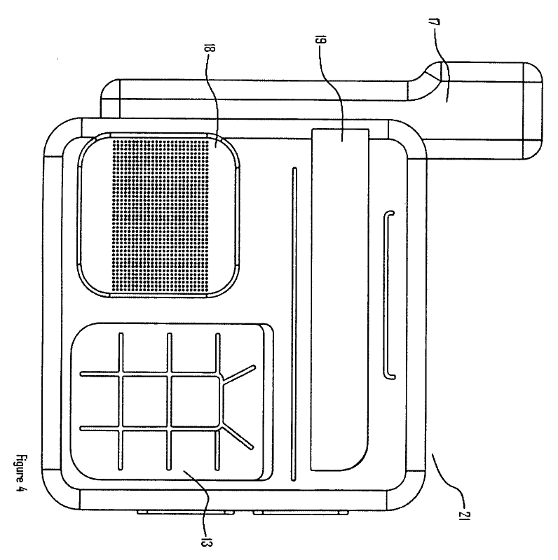

FIG. 4 is a front view of the wireless text messaging system in the two-way radio device comprising a microphone housing 21, the front of housing has a display screen 19 to indicate incoming and outgoing text messages, alphabet keypad 13 consisting sign, symbols and alphabets, to write text messages speaker cum microphone grill 18 and built in antenna 17.

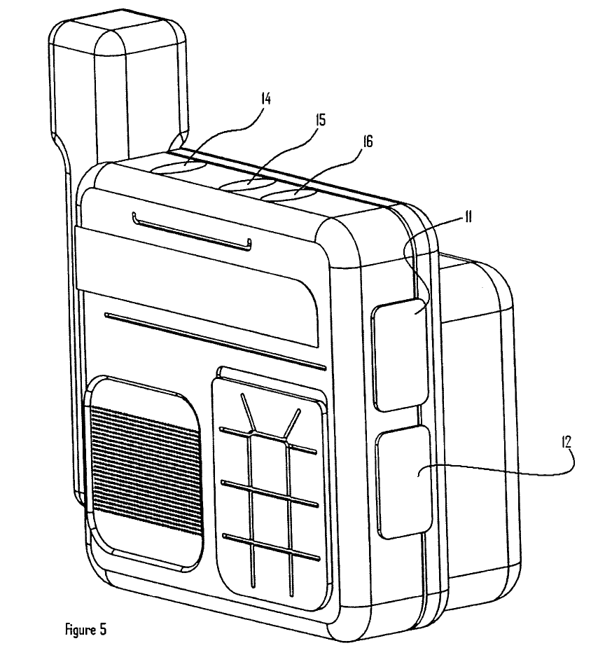

FIG. 5 is a right side view of the wireless text messaging system using two way radio device, buttons 11, 12, 14, 15, 16, positioned on the top and the right side of the device are used to switch on/off the power, to go to menu options, to use text transmission mode and for the illumination purposes.

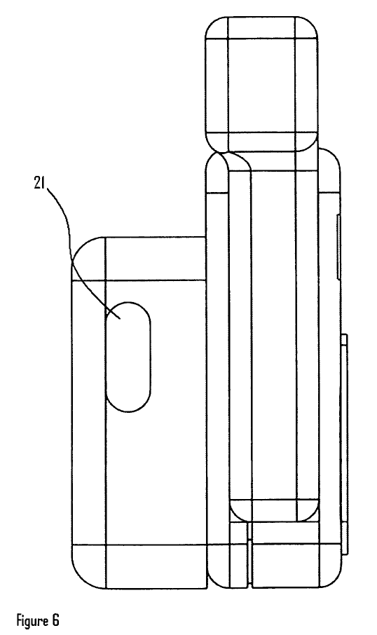

FIG. 6 is a left side view of the wireless text messaging system using two way radio device having a push to talk function 21 to have two way voice chat.

Although a particular preferred embodiment of the invention has been disclosed in detail for illustrative purposes, it will be recognized that variations or modifications of the disclosed apparatus, including the rearrangement of parts, changes in sizes and dimensions, variances in terms of distances of transmission and reception, lie within the scope of the present invention.

1. A wireless messaging system, comprising:
a transreceiver for transmitting and receiving electromagnetic radiations;
a selective call decoder coupled to said transceiver for encoding/decoding radiations; and
a user interface connected to said transreceiver through a processor for compiling and displaying a message unit, whereby
said processor is coupled to the selective call decoder and said transceiver for identifying the message unit.

2. The wireless messaging system of claim 1 wherein said processor includes a first processor for receiving and displaying the message unit from the selective call decoder.

3. The wireless messaging system of claim 2 wherein a received message unit is decoded by the selective call decoder and passed directly to the first processor to display a message.

4. The wireless messaging system of claim 1 wherein said message is a visual message.

5. The wireless messaging system of claim 2 wherein the message unit is encrypted by the first processor and coupled to a secure memory that retains information encrypted from the visual message.

6. The wireless messaging system of claim 2 wherein the message unit comprises a received message session key.

7. The wireless messaging system of claim 1, wherein said processor includes a secure message generator coupled to a first processor.

8. The wireless messaging system of claim 7 wherein the processor encrypts and the message generator generates a message unit that is coupled to the processor for transmission by the transceiver.

9. A portable messaging system, comprising:
a receiver;
a selective call decoder coupled to the receiver;
a processor coupled to the selective call decoder;
a transceiver coupled to the processor, and;
a user interface connected to said processor for compiling and displaying visual messages.

10. A portable messaging system of claim 9 wherein the processor comprises:
a security code processor;
a secure non volatile read only memory coupled to the security code processor;
a secure erasable read only memory coupled to the secure non volatile read only memory;
an input/output interface coupled to the secure erasable read only memory; and
a control logic coupled to the security code processor, the secure non volatile read only memory, the secure erasable read only memory, and the input/output interface;
a processor connected to the selective call decoder, and;
a transreceiver coupled to the processor.

11. The portable messaging system of claim 9 wherein the processor receives and encrypts a visual message coupled from the selective call decoder.

12. The portable messaging system of claim 11 wherein an alert is transmitted with the visual message.

13. The portable messaging system of claim 12 wherein the alert is decoded by the selective call decoder and matched to a corresponding sub-code to prevent reception of unauthorized transmissions.

14. A method to send and receive messages comprising the steps of:
providing a hand-held two way communication device;
encoding/decoding message using a selective call decoder;
transmitting/receiving electromagnetic radiations from/to the hand-held communication device;
identifying a visual message from recieved encoded electromagnetic radiations through a processor, and
displaying the visual message using a user interface.

15. A method of claim 14 wherein the step of encoding includes further steps of encrypting the visual message in a secured format.

16. A method of claim 14 wherein the step of transmitting/receiving includes a further step of storing said visual message in a memory.
